(19) United States
(12) Patent Application Publication
(10) Pub. No.: US 2017/0099840 A1
(43) Pub. Date: Apr. 13, 2017

(54) ACICULAR WOLLASTONITE GRAINS FOR KILLING GRUBS AND METHOD OF MAKING SAME

(71) Applicant: 2005948 ONTARIO LIMITED o/a CANADIAN WOLLASTONITE, London (CA)

(72) Inventor: Robert Allan VASILY, Seeleys Bay (CA)

(21) Appl. No.: 15/284,999

(22) Filed: Oct. 4, 2016

Related U.S. Application Data
(60) Provisional application No. 62/239,623, filed on Oct. 9, 2015.

(51) Int. Cl. A01N 59/06; C05G 3/02; C01B 33/24; A01N 25/12

(52) U.S. Cl. CPC A01N 59/06; A01N 25/12; C05G 3/02; C01B 33/24

(57) ABSTRACT

Herein is disclosed the use of acicular wollastonite grains for killing grubs and method of making the grains. The method includes applying acicular wollastonite grains having an aspect ratio of at least about 5:1 to the ground at an area density of about 0.5 to about 6 mt per acre, with higher amounts in this range chosen for very bad grub infestations. The method of producing the acicular wollastonite grains having an aspect ratio of at least about 5:1, includes feeding wollastonite feedstock into a milling apparatus in conjunction with a screen mechanism. The milling apparatus and screen mechanism have parameters selected to produce acicular wollastonite grains having an aspect ratio of at least about 5:1, which can optionally then be fed to a cyclone where the acicular wollastonite grains are collected.

### FIELD

The present disclosure relates to the use of acicular wollastonite grains for killing grubs and method of making the grains.

### BACKGROUND

Grubs, e.g., white grubs, are the larval stage of a number of species of beetles and are present in soils in every area of North America, particularly east of the Rocky Mountains. Although grass roots are their preferred food source, grubs feed on the roots of a number of plants, including corn, soybeans, legumes, and cereals. Depending on the species, grubs remain in the soil for one to three years. At elevated populations, grubs stunt, weaken, and delay plant growth and can even kill young seedlings or plants experiencing other stresses (e.g., drought). This root feeding results in economic losses for field crop, forage, and sod producers, as well as aesthetic concerns and increased expenses for lawn and turf owners/managers. Secondary damage occurs when skunks, raccoons, and other animals dig up grubs to feed on them. Depending on the species, the adult beetles can cause significant damage to fruit trees and ornamentals.

Grub control options are limited. Common approaches are tillage, which exposes the grubs to predation and death by exposure, chemical insecticides, and biological controls. Tillage obviously destroys the crop or turf that the grubs were feeding on, resulting in a complete loss. Forage producers are commonly directed to rotate to non-host crops and/or to crops for which insecticidal seed treatments are registered.

Chemical insecticides are coming under increasing scientific and public scrutiny, and limitations of use are in place. In particular, neonicotinoids, used to treat seeds and perhaps the most common method of insect control in field crops and turf, are under scrutiny for their off-target effects on bees, pollinators and other wildlife. Their use has been banned or severely restricted in certain jurisdictions. There are a limited number of crops for which insecticides are registered for use, and these products are also affected by cosmetic pesticide bans in several jurisdictions. In general, post-seeding or “rescue treatments” are not available for agricultural producers. Biological controls (bacterial pathogens and nematodes) are weather-dependent and generally regarded as significantly less effective than insecticides. Grub control in turf often relies on neonicotinoid insecticides where they are registered for use; cosmetic pesticide bans restrict the currently-available options for homeowners and turf managers to expensive and often-ineffective nematode applications.

As a result of the above factors, there is a growing need for alternative grub control strategies and products.

### SUMMARY

The present disclosure relates to use of acicular wollastonite grains for killing grubs, e.g., white grubs, and method of making the grains.

More particularly, herein is disclosed the use of acicular wollastonite grains for killing grubs and method of making the grains. The method includes applying acicular wollastonite grains having an aspect ratio of at least about 5:1 to the ground at an area density of about 0.5 to about 6 metric tonnes (mt) per acre, with the higher coverage used when there is a bad grub infestation. The method of producing the acicular wollastonite grains having an aspect ratio of at least about 5:1, includes feeding wollastonite feedstock into a milling apparatus in conjunction with a screen mechanism. The milling apparatus and screen mechanism have parameters selected to produce acicular wollastonite grains having an aspect ratio of at least about 5:1. These grains may then be fed to a cyclone where the wollastonite grains having the desired aspect ratio are collected.

Also disclosed herein is a combination fertilizer and grub killing composition, comprising:

fertilizer mixed with acicular wollastonite grains, the wollastonite grains having an aspect ratio of at least about 5:1, the wollastonite grains being present in the composition in an amount such that when the composition is applied to the ground the wollastonite grains are applied at an area density of about 0.5 to about 6 mt per acre. In some embodiments, the composition further comprises seeds.

A further understanding of the functional and advantageous aspects of the disclosure can be realized by reference to the following detailed description and drawings.

### BRIEF DESCRIPTION OF THE DRAWINGS

Embodiments of the use of acicular wollastonite grains for killing grubs and method of making the grains will now be described, by way of example only, with reference to the drawings, in which:

FIG. 1 shows a 120× scanning electron microscope (SEM) image of acicular wollastonite grains that have been milled and screened to preserve the mineral's needle-like structure.

FIG. 2 shows a 400× SEM image of the acicular wollastonite grains.

FIG. 3 shows an SEM image of typical conventionally ground wollastonite.

FIG. 4 is a schematic representation of a non-limiting example of a system used to prepare the high aspect ratio needle-like wollastonite grains disclosed herein.

FIG. 5 is a schematic representation of a typical cyclone that may be employed in the system of FIG. 4.

### DETAILED DESCRIPTION

Various embodiments and aspects of the disclosure will be described with reference to details discussed below. The following description and drawings are illustrative of the disclosure and are not to be construed as limiting the disclosure. The drawings are not necessarily to scale. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in this specification including claims, the terms “comprises” and “comprising” and variations thereof mean that the specified features, steps or components are included. These terms are not to be interpreted to exclude the presence of additional features, steps or components.

As used herein, the term “exemplary” means “serving as an example, instance, or illustration,” and should not necessarily be construed as preferred or advantageous over other configurations disclosed herein.

As used herein, the terms “about” and “approximately”, when used in conjunction with ranges of dimensions of grains, compositions of mixtures or other physical properties or characteristics, are meant to cover slight variations that may exist in the upper and lower limits of the ranges of dimensions so as not to exclude embodiments where on average most of the dimensions are satisfied but where statistically dimensions may exist outside this region. It is not the intention to exclude embodiments such as these from the present disclosure.

As used herein, the term “acicular wollastonite” refers to a wollastonite crystal habit comprising a radiating mass of slender, needle-like grains, or to such individual grains.

As used herein, the term “aspect ratio” refers to proportional ratio between length and width, e.g., of acicular wollastonite grains.

As used herein, the term “gangue minerals” refers to surrounding or mixed-in minerals that are generally not the desired mineral. For the purposes of the present method disclosed herein, gangue minerals co-located with wollastonite, will, for example, not be acicular or needle-like.

As used herein, the term “ground” refers to an area or surface which may or may not comprise plants. Accordingly, “ground” comprises bare fields, lawns or gardens as well as those having turf, crops or other plants.

The present disclosure relates to the use of acicular wollastonite grains as an effective, inexpensive and safe method of grub control. The wollastonite used is prepared in such a way as to produce acicular wollastonite grains with high aspect ratios. When grubs come into contact with the grains, the grains act as sharp needles or spears that lacerate the soft-bodied larvae, leading to their desiccation and death.

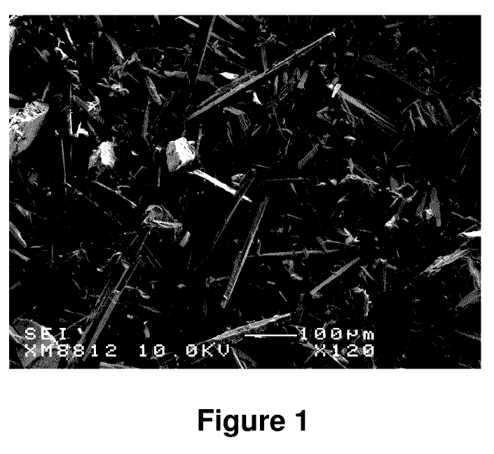

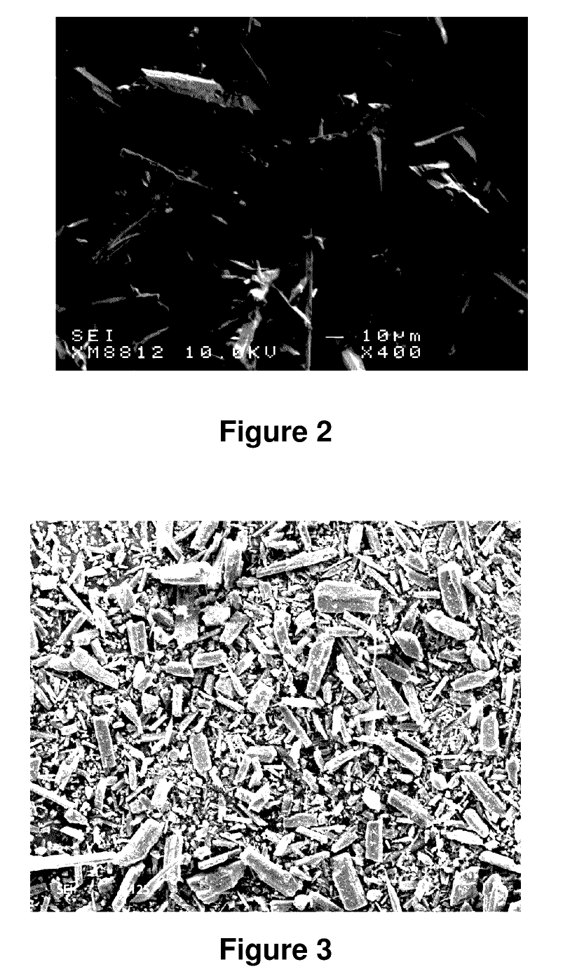

FIGS. 1 and 2 show SEM images of acicular wollastonite grains (“needles”) at 120× and 400× magnification, respectively. The acicular wollastonite grains have been milled and screened as described below to preserve the mineral's needle-like structure. Maintaining the needle-like structure of the wollastonite is central to its effectiveness in the present grub control applications. The needle-like grains lacerate and puncture the bodies of the grubs and create a harsh environment where they cannot survive. The grains shown are very effective in killing grubs.

FIG. 3 shows an SEM image of typical conventionally ground wollastonite which is characteristic of most wollastonite production in the world today. Wollastonite in this form and crystal habit has limited effectiveness in grub control relative to that shown in FIGS. 1 and 2, based on studies by the present inventor.

The wollastonite ore used in the methods described below originated from the Saint Lawrence Wollastonite Deposit, owned by Canadian Wollastonite (div of 2005948 Ontario Limited). Other wollastonite ore sources may also be used providing the wollastonite grains found in the ore body are relatively pure with few inclusions, which allows the grains to be separated and retain their acicular habit. The mineralogy of the St. Lawrence Wollastonite ore is well defined through numerous studies. In general, the ore contains wollastonite, diopside and feldspars as major minerals, and quartz calcite and sulphides as minor minerals. Wollastonite in this ore displays irregular but sharp grain boundaries with the gangue minerals. The grains of wollastonite are relatively pure making this particular ore body well suited for producing the high aspect particles required by the present methods. The ore's composition and liberation size is shown in Table 1.

TABLE 1
Mineral composition and liberation profile
at 48 mesh size of the ore used in this study

| | | | | Liberation | |
|---|---|---|---|---|---|
| Mineral | Wt % | Size | | at 48 mesh | Textural Comments |
| Wollastonite | 44 | 20-1000 | μm | 99% | Commonly forms subhedral particles |
| | | | | | ranges in habit from prismatic to columnar |
| | | | | | to acicular and platy. |
| | | | | | It is typically fresh with scarce calcite and |
| | | | | | prehnite alteration. |
| Diopside | 31 | 50-1000 | μm | 99% | Subhedral, angular, tabular and stubby |
| | | | | | crystals |
| | | | | | Variably replaced by prehnite, calcite |
| | | | | | hosts minor inclusions of other diopside |
| | | | | | grains. |
| Feldspars | 17 | 50-450 | μm | 99% | Feldspars are mainly microcline, less |
| | | | | | albite, angular grains. |
| Quartz | 6 | <20-350 | μm | 99% | Anhedral, angular grains, liberated, with |
| | | | | | minor intergrowths with feldspars. |
| Calcite | 1 | <20-400 | μm | 99% | Minor anhedral and angular grains, |
| | | | | | typically liberated, and alteration to |
| | | | | | wollastonite. |
| Titanite | 0.2 | <150 | μm | 99% | Minor anhedral, liberated grains. |
| Garnet | <0.1 | <100 | μm | 99% | Minor anhedral, liberated grains. |
| Sulfides | 0.5 | <10-200 | μm | 99% | Anhedral, pyrrhotite, liberated. |

How the ore was crushed was not shown to be critical for the methods according to the invention. Conventional aggregate production methods used in most quarries result in the production of 19 mm ore which can conveniently become the feedstock for the grinding and classification circuits.

The selection of the grinding and the classification approaches is important, not only for generating high aspect ratio grains, but also because such selection affects the sharpness of the wollastonite separation from the gangue minerals. A convenient grinding tool is a ceramic ball mill with a specific ball composition (see examples below). Other mill types may be used, provided they discharge the ground material quickly without destroying the acicular needles. This investigation found that three staged grinding using ceramic ball mills optimized the production of the desired wollastonite needles.

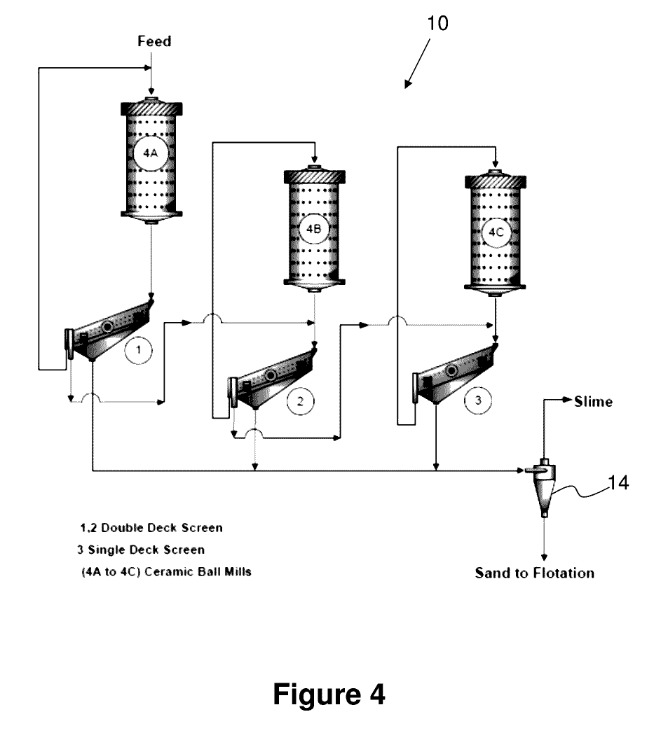

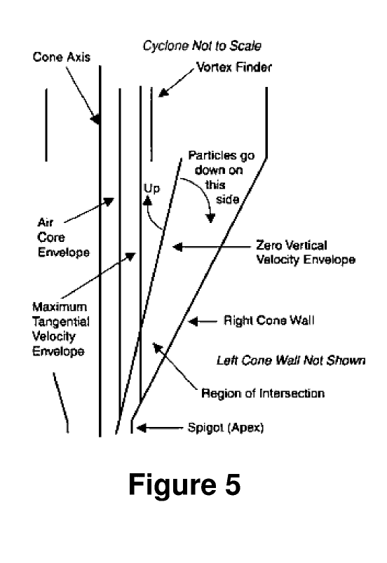

FIG. 4 is a schematic representation of a non-limiting example of a system (shown generally at 10) that is used to prepare the high aspect ratio needle-like wollastonite grains disclosed herein. Exemplary system 10 includes three (3) ceramic ball mills 4A, 4B and 4C. Ball mill 4A accepts the raw feedstock and mills it. The milled wollastonite is passed to a double deck screen 1. Grains having the appropriate size/aspect ratio that pass through both of the screens are optionally fed to cyclone 14 where the fine and ultra-fine particles are removed (see FIG. 5 for a schematic depiction of a typical cyclone). Those particles that do not pass through the first screen are recirculated back to the input of ball mill 4A to undergo further milling, and those that pass through the first screen but are too large to pass through the second screen are routed to the entrance of double deck screen 2. Those grains too large to pass through both screens of double deck screen 2 are routed into the input of ball mill 4B to be further milled and then passed back to double deck screen 2. Those that pass through both screens may optionally be routed to cyclone 14, and those that pass through the first screen but not the second screen are routed to single deck screen 3. Those grains that pass through the screen 3 may optionally be passed to cyclone 14 and those too large are circulated to ball mill 4C to be further milled.

The parameters of the three (3) ball millers 4A, 4B and 4C and of the double and single deck screens 1, 2 and 3 are selected to produce acicular wollastonite grains having an aspect ratio of at least about 5:1. The output of the ball millers 4A, 4B and 4C may be passed to cyclone 14 which takes out the ultra-fine particles (slimes) that that are not wanted. The wollastonite grains may optionally be passed to the cyclone 14 such that those having an aspect ratio of at least about 5:1 that pass through cylone 14 may be collected.

The acicular wollastonite grains of the methods and products described herein may have an aspect ratio of at least about 8:1. Said acicular wollastonite grains may have an aspect ratio of at least about 10:1. Said acicular wollastonite grains may have an aspect ratio of at least about 20:1. Said acicular wollastonite grains may have an aspect ratio in a range of at least about 7:1 to about 20:1, or from about 10:1 to about 20:1.

The wollastonite grains having the desired aspect ratio may be applied to the ground in an amount from about 0.5 mt per acre to about 6 mt per acre. For high or bad grub infestations higher amounts in this range would be chosen. The wollastonite grains may also be applied to the ground in any range within the above-stated range, a non-limiting example being about 1.5 mt to about 2.5 mt per acre.

The relevant grindability data for the St. Lawrence ore is as follows:

Ball mill bone work index at 48 mesh=10.3 metrics

Grinding media=high specific gravity ceramic balls or slags

Feed size=10 mm

Product size K80=2.04 microns

Classification equipment=High frequency Derrick screen decks (Derrick Corp., Texas)

Table 2 shows the effect of ceramic ball composition (size, weight and media type) on the aspect ratio of the wollastonite grains when using a Derrick slotted screen (Derrick Corp., Texas).

TABLE 2
Effect of the ceramic ball size composition
on the aspect ratio of wollastonite

| Ball Composition | Average Aspect Ratio |
|---|---|
| Composition A | 8 |
| Composition B | 9 |
| Composition C | 10 |
| Composition D | 11 |

The type of screen and screen deck also had a significant effect on the generating and preserving of the wollastonite needles. Table 3 shows the average aspect ratio obtained using different screen types and screen decks.

TABLE 3
Effect of screen type and screen deck on aspect ratio
(using ceramic grinding media)

| Screen and Deck Type | Average Aspect Ratio |
|---|---|
| Derrick screen, slotted 48 mesh deck | 11.0 |
| Vibrating screen, standard 48 mesh deck | 9.0 |
| Vibration screen, slotted 48 mesh deck | 12.5 |

Additional investigations into the optimal needle fineness for killing grubs is ongoing, but strong results have been observed with needles passing 48 mesh and retained on 200 mesh.

The particular ball mills used in the described work were Allis Chalmers 5′×9′ with 75 hp motors. The Derrick screens were model F48-90MS-3. The cyclone was a Mozley 5″. However, such equipment can be substituted with equipment obtained from other manufacturers, provided that the desired aspect ratio of the wollastonite grains is maintained.

Studies conducted by the inventor have shown very high efficacy of the acicular wollastonite grains described herein for killing grubs. An initial study took place on a sod farm north of Toronto, Ontario, Canada, where the product was applied to several 100 square foot plots randomly selected in a turfgrass field at an area density (surface density) equivalent to approximately 1.5 mt per acre. The product was applied onto the sod using a conventional solid fertilizer applicator. The sod was aerated to assist product migration into the root mass. Subsequent visual observations revealed that the grass in the treated areas was darker green in colour, with a higher plant density. This was initially assumed to be a fertilizing effect, but at harvest it was noted that this turf did not show evidence of grub root-feeding, and there were no grubs present in the soil, in direct contrast to the surrounding field.

To verify the hypothesis that the product was controlling the grub population, grubs at various life stages were collected from the farm's soil and placed on boards covered with the product so that the direct effect of the product could be observed. The grubs showed an immediate aversion to the product. The smallest, first-instar grubs died within 40 minutes of contact. The largest specimens were desiccated and dead within 12 to 14 hours.

The sod farm and other growers who have used this product in trials have not observed a negative impact on earthworm populations. Further evaluations at this farm and others across Ontario and Quebec, including studies involving field row crops, are currently underway.

Conveniently, acicular wollastonite grains according to the invention may be produced and incorporated into fertilizers, including, for example, starter fertilizers. Conveniently, acicular wollastonite grains according to the invention may be applied to the ground using the same equipment as that used for fertilizers, including, for example, starter fertilizers. A starter fertilizer is a mix that also contains the seed of the desired crop, for example, corn. According to the present invention, acicular wollastonite grains present in a starter fertilizer mix including corn seed would surround the corn seed and provide a harsh environment that would repel or kill grubs.

The above embodiments present advantages, particularly as reduced, minimal, and no-till practices are increasing in prominence.

Another potential method of controlling grubs is by using a white powder known as diatomaceous earth (DE). Diatomaceous earth is an organic concoction made of the fossilized remains of tiny one-celled marine animals known as diatoms. Chemically, DE is essentially pure silicon dioxide. To humans, DE can feel very soft to the touch, but to soft-bodied insects dry DE presents sharp edges that may shred them as they touch it. However, in contrast to the acicular wollastonite grains described herein, the efficacy of DE is significantly compromised in moist environments, where the product absorbs water and literally loses its “edge.” Acicular wollastonite grains remain anhydrous and efficacious in moist environments.

Another serious drawback to the use of DE is that the inhalation of crystalline silica can be harmful to the lungs, causing silicosis. While amorphous silica is considered to have low toxicity, prolonged inhalation of crystalline silica causes changes to the lungs. Though DE is mostly composed of amorphous silica, it can contain some crystalline silica, especially in saltwater forms. Hence precautions are recommended when handling this fine powder, such as wearing breathing filters and the like.

An advantage of using the acicular wollastonite grains disclosed herein is that they present no known medical risks. The grains in the above disclosed size ranges do not have the smaller size dimensions typical with powdered diatomaceous earth. Thus, acicular wollastonite grains require fewer precautions than DE when being handled or spread on turf, gardens or fields.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Therefore what is claimed is:

1. A method for killing grubs, comprising:
producing acicular wollastonite grains having an aspect ratio of at least about 5:1, and
applying the acicular wollastonite grains to the ground at an area density of about 0.5 to about 6 mt per acre.

2. The method according to claim 1, wherein the acicular wollastonite grains are applied to the ground at an area density of about 1.5 to about 2.5 mt per acre.

3. The method according to claim 1, wherein the acicular wollastonite grains have an aspect ratio of at least about 8:1.

4. The method according to claim 1, wherein the acicular wollastonite grains have an aspect ratio of at least about 10:1.

5. The method according to claim 1, wherein the acicular wollastonite grains have an aspect ratio of at least about 20:1.

6. The method according to claim 1, wherein the acicular wollastonite grains have an aspect ratio of in a range from at least about 7:1 to about 20:1.

7. The method according to claim 1 wherein producing acicular wollastonite grains having an aspect ratio of at least about 5:1 includes:
feeding wollastonite feedstock into a milling apparatus, said milling apparatus in conjunction with a screen mechanism, said milling apparatus and said screen mechanism having parameters selected to produce acicular wollastonite grains having an aspect ratio of at least about 5:1; and
optionally feeding said wollastonite grains having an aspect ratio of at least about 5:1 to a cyclone and collecting said wollastonite grains passing through said cyclone.

8. A method for killing grubs, comprising:
applying acicular wollastonite grains having an aspect ratio of at least about 5:1 to the ground at an area density of about 0.5 to about 6 mt per acre.

9. A method of producing acicular wollastonite grains, comprising:
feeding wollastonite feedstock into a milling apparatus, said milling apparatus in conjunction with a screen mechanism, said milling apparatus and said screen mechanism having parameters selected to produce acicular wollastonite grains having an aspect ratio of at least about 5:1.

10. The method according to claim 9 including feeding said wollastonite grains having an aspect ratio of at least about 5:1 to a cyclone and collecting said wollastonite grains passing through said cyclone.

11. The method according to claim 9 wherein said milling apparatus comprises a ball mill.

12. The method according to claim 9 wherein said milling apparatus comprises two or more ball mills configured in a cascading configuration, each having an associated screen mechanism.

13. The method according to claim 9, wherein the acicular wollastonite grains have an aspect ratio of at least about 8:1.

14. The method according to claim 9, wherein the acicular wollastonite grains have an aspect ratio of at least about 10:1.

15. The method according to claim 9, wherein the acicular wollastonite grains have an aspect ratio of at least about 20:1.

16. The method according to claim 9, wherein the acicular wollastonite grains have an aspect ratio of at least about 7:1 to about 20:1.

17. A fertilizer and grub killing composition, comprising:
fertilizer mixed with acicular wollastonite grains, the wollastonite grains having an aspect ratio of at least about 5:1, the wollastonite grains being present in the composition in an amount such that when the composition is applied to the ground the wollastonite grains are applied at an area density of at least about 0.5 to about 6 mt per acre.

18. The method according to claim 17, wherein the acicular wollastonite grains are present in the composition in an amount such that when the composition is applied to the ground the wollastonite grains are applied at an area density of about 1.5 to about 2.5 mt per acre.

19. The composition according to claim 17, wherein the mixture further comprises seeds.

20. The composition according to claim 18, wherein the mixture further comprises seeds.
